(19) United States
(12) Patent Application Publication
(10) Pub. No.: US 2024/0393800 A1
(43) Pub. Date: Nov. 28, 2024

(54) MOVING BODY CONTROL SYSTEM, MOVING BODY CONTROL METHOD, AND IMAGE COMMUNICATION DEVICE

(71) Applicant: NEC Corporation, Minato-ku, Tokyo (JP)

(72) Inventors: Natsuki KAI, Tokyo (JP); Hiroshi YOSHIDA, Tokyo (JP)

(73) Assignee: NEC Corporation, Minato-ku, Tokyo (JP)

(21) Appl. No.: 18/694,125

(22) PCT Filed: Oct. 1, 2021
(86) PCT No.: PCT/JP2021/036427

§ 371 Date: Mar. 21, 2024

(51) Int. Cl. G05D 1/243; B66F 9/24; G05D 1/622

(52) U.S. Cl. CPC G05D 1/2435; B66F 9/24; G05D 1/622

(57) ABSTRACT

In order to make it possible to control, according to a content of action of a moving body, an information amount of depth information so that the information amount of the depth information becomes appropriate, this invention includes: an obtaining section (11) that obtains a content of action of a moving body; and a control section (12) that controls, according to the content of the action of the moving body, an information amount of depth information obtained from a sensor.

### TECHNICAL FIELD

The present invention relates to a moving body control system, a moving body control method, and an image communication apparatus.

### BACKGROUND ART

Conventionally, there has been developed a technique that controls a robot with use of an image obtained by a depth sensor. Examples of a technique related to this include the following inventions disclosed in Patent Literatures 1 and 2.

Patent Literature 1 discloses a technique according to which an information processing apparatus provided inside or outside a robot (i) derives information relating to a position or a posture of a robot on the basis of a sensing result given by a sensor mounted on the robot and (ii) controls the robot.

### CITATION LIST

### Patent Literature

### [Patent Literature 1]

International Publication No. WO 2021/033509

### [Patent Literature 2]

Japanese Patent Application Publication, Tokukai, No. 2015-008367

### SUMMARY OF INVENTION

### Technical Problem

In a case where, in the system disclosed in Patent Literature 1, the information processing apparatus is provided outside the robot, the robot needs to send, to the information processing apparatus, an image obtained by the sensor. However, if the robot sends the sensing result as it is, a network band may be narrowed. This may possibly cause delay in transmission of the sensing result, for example.

An example aspect of the present invention was made in consideration of the above problem, and an example object thereof is to provide a technique capable of controlling, according to a content of action of a moving body, an information amount of depth information so that the information amount of the depth information becomes appropriate.

### Solution to Problem

A moving body control system in accordance with an example aspect of the present invention includes: an obtaining means that obtains a content of action of a moving body; and a control means that controls, according to the content of the action of the moving body, an information amount of depth information obtained from a sensor.

A moving body control method in accordance with an example aspect of the present invention includes: obtaining a content of action of a moving body; and controlling, according to the content of the action of the moving body, an information amount of depth information obtained from a sensor.

An image communication apparatus in accordance with an example aspect of the present invention includes: a receiving means that receives a parameter relating to a change in information amount, the change having been determined according to a content of action of a moving body; and a control means that controls, according to the parameter, an information amount of depth information obtained from a sensor.

### Advantageous Effects of Invention

In accordance with an example aspect of the present invention, it is possible to control, according to a content of action of a moving body, an information amount of depth information so that the information amount of the depth information becomes appropriate.

### BRIEF DESCRIPTION OF DRAWINGS

FIG. 1 is a block diagram illustrating a functional configuration of a moving body control system in accordance with a first example embodiment of the present invention.

FIG. 2 is a flowchart illustrating a flow of the moving body control method.

FIG. 3 is a block diagram illustrating a functional configuration of an image communication apparatus in accordance with a second example embodiment of the present invention.

FIG. 4 is a block diagram illustrating a functional configuration of a server apparatus in accordance with a third example embodiment of the present invention.

FIG. 5 is a block diagram illustrating a configuration of a moving body control system in accordance with a fourth example embodiment of the present invention.

FIG. 6 is a view for illustrating a quantization range of depth information.

FIG. 7 is a view illustrating 16-bit depth information and 8-bit gray-scale information.

FIG. 8 is a view illustrating another example of a quantization process.

FIG. 9 is a flowchart illustrating a flow of a moving body control method in accordance with a fourth example embodiment of the present invention.

FIG. 10 is a block diagram illustrating a configuration of a moving body control system in accordance with a fifth example embodiment of the present invention.

FIG. 11 is a flowchart illustrating a flow of a moving body control method in accordance with the fifth example embodiment of the present invention.

FIG. 12 is a view illustrating an example of hardware of a computer.

### DESCRIPTION OF EMBODIMENTS

### First Example Embodiment

The following description will discuss a first example embodiment of the present invention in detail with reference to the drawings. The present example embodiment is an embodiment serving as a basis for example embodiments described later.

### <Outline of Moving Body Control System 100>

Schematically, a moving body control system 100 in accordance with the present example embodiment is configured to change, according to a content of action of a moving body, an information amount of depth information obtained by a sensor.

### <Configuration of Moving Body Control System 100>

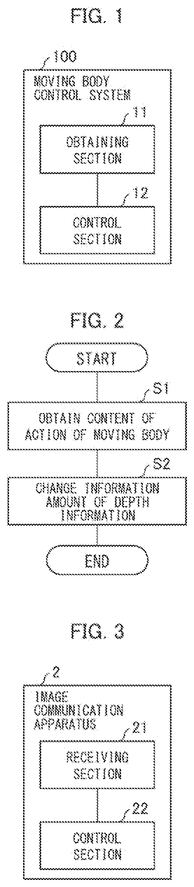

The following will describe, with reference to FIG. 1, a configuration of the moving body control system 100 in accordance with the present example embodiment. FIG. 1 is a block diagram illustrating a configuration of the moving body control system 100.

As shown in FIG. 1, the moving body control system 100 includes an obtaining section 11 and a control section 12. The obtaining section 11 is a configuration realizing an obtaining means in the present example embodiment. The control section 12 is a configuration realizing a control means in the present example embodiment.

Depth information may be changed according to a throughput of a network connected to a moving body. For example, in a case of RAW data (30 fps (flame per second)) of a HD (High Definition) image, a color image consumes 660 Mbps of a network band and a depth image consumes 440 Mbps of the network band. Thus, when a communication throughput of the network is not adequate, it is necessary to reduce one of or both of an information amount of the color image and an information amount of the depth image.

The sensor obtains the depth information. Examples of the sensor includes an RGB-D camera provided with a depth sensor, a 3D light detection and ranging (LiDAR) sensor, and a time-of-flight (TOF) sensor. The sensor may obtain, in addition to the color image, a depth image representing a depth of the color image. It should be noted that the depth information indicates a distance from the sensor to an object present in a surrounding area.

One or more sensors are provided to the moving body. The obtaining section 11 obtains a color image and depth information output from the one or more sensors. The depth information represents depths of pixels of the color image by, e.g., 16 bits (0 to 65535 [mm]). The control section 12 can change the information amount of the depth information by compressing the depth image and/or reducing a data amount of the depth information. For example, the control section 12 can change the information amount of the depth information by converting 16-bit depth information into 8-bit depth information.

For example, in compressing the color image and depth information by moving picture experts group (MPEG), a compression rate can be controlled by changing a quantum parameter. A parameter, such as the quantum parameter, which gives an influence on the compression rate will be referred to as a “compression parameter”.

The obtaining section 11 obtains a content of action of the moving body. Examples of the moving body include an automated guided forklift (AGF), an automated guided vehicle (AGV), and an autonomous mobile robot (AMR), each provided with a mechanism for automated guidance.

The moving body has, for example, a simultaneous localization and mapping (SLAM) function. The moving body may estimate self-location by using an external sensor (e.g., a camera and/or a laser sensor) and an internal sensor (e.g., an encoder and/or a gyro sensor) in combination. Further, the moving body may have a function to automatically generate a traveling path to autonomously avoid an obstacle, without being bound by a fixed route, for example.

For example, in a case where the moving body is an automated guided forklift, contents of work are roughly divided into two, “traveling” and “loading and unloading”. If the automated guided forklift carries out “traveling”, the automated guided forklift moves toward a destination while estimating self-location by VSLAM mainly using a color image. Thus, by increasing the information amount of the color image and reducing the information amount of the depth image, it is possible to estimate self-location more accurately.

In a case where the automated guided forklift carries out “traveling”, if an obstacle is present in a traveling direction of the automated guided forklift, the automated guided forklift needs to make a temporary stop or avoid the obstacle. In order to avoid the obstacle, the automated guided forklift needs to obtain the depth information of the obstacle with high accuracy. For this purpose, the information amount of the depth information is increased, and the information amount of the color image is reduced.

Meanwhile, in a case where the automated guided forklift carries out “loading and unloading”, the automated guided forklift carries out a loading/unloading process while mainly carrying out palette recognition, rack recognition, QR marker recognition, and/or the like. At the time of the palette recognition and rack recognition, the automated guided forklift needs to obtain depth information of the palette and depth information of the rack with high accuracy. For this purpose, the information amount of the depth image is increased, and the information amount of the color image is reduced. At the time of the QR marker recognition, the automated guided forklift needs to carry out image processing of the QR marker. For this purpose, the information amount of the color image is increased, and the information amount of the depth image is reduced.

Assume a case where the moving body moves according to a marker such as magnetic tape, for example. In such a case, when the moving body moves along the marker, the control section 12 may reduce the depth information. Meanwhile, when the moving body moves while deviating from a route assumed on the basis of, e.g., action of avoiding an obstacle, the control section 12 may increase the depth information. Further, in a case where the moving body conveys an object, the control section 12 may increase the depth information at the time of delivery of the object.

The control section 12 controls, according to a content of action of the moving body, the information amount of the depth information obtained from the sensor. For example, in a case where the moving body is an automated guided forklift and the automated guided forklift is carrying out “traveling”, the control section 12 reduces the information amount of the depth information. In a case an obstacle is present in a traveling direction of the automated guided forklift, the control section 12 increases the information amount of the depth information.

It should be noted that functions of the moving body control system 100 may be implemented in a cloud. For example, the obtaining section 11 may be a single apparatus, and the control section 12 may be a single apparatus. The obtaining section 11 and the control section 12 may be mounted in a single apparatus or in respective different apparatuses. For example, in a case where these sections are mounted in respective different apparatuses, information of these sections is exchanged via a communication network so as to proceed with a process.

### <Effects of Moving Body Control System 100>

As described above, with the moving body control system 100 in accordance with the present example embodiment, the control section 12 controls the information amount of the depth information according to the content of the action of the moving body. Therefore, it is possible to suitably control the information amount of the depth image for use in the moving body control.

### <Flow of Moving Body Control Method by Moving Body Control System 100>

The following will describe, with reference to FIG. 2, a flow of a moving body control method executed by the moving body control system 100 configured as above. FIG. 2 is a flowchart illustrating a flow of the moving body control method. As shown in FIG. 2, the moving body control method includes steps S1 and S2.

First, the obtaining section 11 obtains a content of action of a moving body (S1). Then, the control section 12 controls, according to the obtained content of the action of the moving body, an information amount of depth information obtained from the sensor (S2).

### <Effects of Moving Body Control Method>

As described above, with the moving body control method in accordance with the present example embodiment, step S2 controls, according to the obtained content of the action of the moving body, the information amount of the depth information obtained from the sensor. Therefore, it is possible to control the information amount of the depth image so that the information amount of the depth information for use in the moving body control becomes appropriate.

### Second Example Embodiment

The following description will discuss a second example embodiment of the present invention in detail with reference to the drawings. An image communication apparatus in accordance with the present example embodiment is mounted in, for example, a moving body, and is configured to change an information amount of depth information obtained by a sensor.

### <Configuration of Image Communication Apparatus 2>

The following will describe, with reference to FIG. 3, a configuration of an image communication apparatus 2 in accordance with the present example embodiment. FIG. 3 is a block diagram illustrating a functional configuration of the image communication apparatus 2. As shown in FIG. 3, the image communication apparatus 2 includes a receiving section 21 and a control section 22. The receiving section 21 is a configuration realizing a receiving means in the present example embodiment. The control section 22 is a configuration realizing a control means in the present example embodiment.

The receiving section 21 receives a parameter relating to a change in information amount, the change having been determined according to a content of action of a moving body. As will be described later, the parameter relating to the change in the information amount is transmitted from a server apparatus. The parameter relating to the change in the information amount includes an assigned bit rate amount for a color image, an assigned bit rate amount for depth information, and/or the like.

For example, in a case where the moving body is an automated guided forklift, contents of work are roughly divided into two, “traveling” and “loading and unloading”. The “traveling” includes “normal traveling”, “avoiding an obstacle”, and/or the like. The “loading and unloading” includes “palette recognition”, “rack recognition”, “QR marker recognition”, and/or the like.

The server apparatus obtains a content of action of an automated guided forklift, and determines, according to the content of the action of the automated guided forklift, a parameter including, e.g., an assigned bit rate amount for a color image and an assigned bit rate amount fir a depth image. Then, the server apparatus transmits the parameter to the image communication apparatus 2.

The control section 22 changes, according to the parameter, the information amount of the depth information obtained from the sensor. For example, the control section 22 changes a compression rate of the depth information in accordance with the assigned bit rate amount of the depth information included in the parameter received by the receiving section 21, and changes the information amount of the depth information so that the information amount corresponds to the assigned bit rate amount of the depth information.

### <Effects of Image Communication Apparatus 2>

As described above, with the image communication apparatus 2 in accordance with the present example embodiment, the control section 22 changes the information amount of the depth information obtained from the sensor, in accordance with the parameter relating to change in the information amount, the change having been determined according to the content of the action of the moving body. Therefore, it is possible to control the information amount of the depth image so that the information amount of the depth information for use in the moving body control becomes appropriate.

### Third Example Embodiment

The following description will discuss a third example embodiment of the present invention in detail with reference to the drawings. A server apparatus in the present example embodiment is configured to obtain a content of action of a moving body and determine, according to the content of the action of the moving body, a parameter for changing an information amount of depth information.

### <Configuration of Server Apparatus 3>

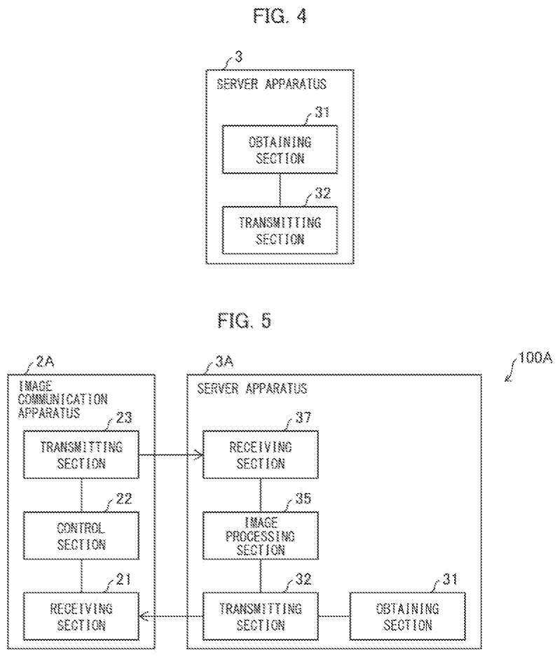

The following will describe, with reference to FIG. 4, a configuration of a server apparatus 3 in accordance with the present example embodiment. FIG. 4 is a block diagram illustrating a functional configuration of the server apparatus 3. As shown in FIG. 4, the server apparatus 3 includes an obtaining section 31 and a transmitting section 32. The obtaining section 31 is a configuration realizing an obtaining means in the present example embodiment. The transmitting section 32 is a configuration realizing a transmitting means in the present example embodiment.

The obtaining section 31 obtains a content of action of a moving body. For example, in a case where the moving body is an automated guided forklift, contents of work are roughly divided into two, “traveling” and “loading and unloading”. The “traveling” includes “normal traveling”, “avoiding an obstacle”, and/or the like. The “loading and unloading” includes “palette recognition”, “rack recognition”, “QR marker recognition”, and/or the like. The content of the work of the moving body is managed by another server apparatus or the like. The obtaining section 31 obtains, from another server apparatus or the like, information indicating to which of the above the content of the work of the moving body corresponds.

The transmitting section 32 determines, according to the content of the action of the moving body, a parameter for changing an information amount of depth information obtained from a sensor, and transmits the parameter to the moving body. The parameter relating to the change in the information amount includes an assigned bit rate amount for a color image, an assigned bit rate amount for depth information, and/or the like. The transmitting section 32 determines, on the basis of a communication throughput between the moving body and the server apparatus 3 and the content of the work of the moving body, a parameter including the assigned bit rate amount for the color image, the assigned bit rate amount for the depth information, and/or the like. Then, the transmitting section 32 transmits the parameter to the moving body.

### <Effects of Server Apparatus 3>

As described above, with the server apparatus 3 in accordance with the present example embodiment, the transmitting section 32 determines, according to the content of the action of the moving body, the parameter for changing the information amount of the depth information obtained from the sensor, and transmits the parameter to the moving body. Accordingly, the moving body receives this parameter, and changes, according to the parameter, the information amount of the depth image representing the depth of the color image obtained from the sensor. This makes it possible to control the information amount of the depth information so that the information amount of the depth information for use in the moving body control becomes appropriate.

### Fourth Example Embodiment

The following description will discuss a fourth example embodiment of the present invention in detail with reference to the drawings. It should be noted that members having identical functions to those of the second and third example embodiments are given identical reference signs, and a description thereof will be omitted.

### <Configuration of Moving Body Control System 100A>

The following will describe, with reference to FIG. 5, a configuration of a moving body control system 100A in accordance with the present example embodiment. FIG. 5 is a block diagram illustrating a configuration of the moving body control system 100A.

As shown in FIG. 5, the moving body control system 100A includes an image communication apparatus 2A and a server apparatus 3A. The image communication apparatus 2A includes a receiving section 21, a control section 22, and a transmitting section 23. The receiving section 21 is a configuration realizing a receiving means of the image communication apparatus in the present example embodiment. The control section 22 is a configuration realizing a control means in the present example embodiment. The transmitting section 23 is a configuration realizing a transmitting means of the image communication apparatus in the present example embodiment.

The server apparatus 3A includes an obtaining section 31, a transmitting section 32, an image processing section 35, and a receiving section 37. The obtaining section 31 is a configuration realizing an obtaining means in the present example embodiment. The transmitting section 32 is a configuration realizing a control means or a transmitting means of the server apparatus in the present example embodiment. The image processing section 35 is a configuration realizing an image processing means in the present example embodiment.

The obtaining section 31 of the server apparatus 3A obtains a content of action of a moving body. The content of the action of the moving body may be managed by another server apparatus, for example. The obtaining section 31 of the server apparatus 3A may obtain, from another server apparatus or the like, information relating to the content of the work of the moving body.

The server apparatus 3A may include, in its inside, a planning section that plans action of the moving body and a retaining section that retains the plan of the action of the moving body. The obtaining section 31 may obtain, from the planning section or retaining section, the content of the work of the moving body.

The transmitting section 32 of the server apparatus 3A changes, according to the content of the action of the moving body, approximation accuracy for use in approximation of the depth information. Then, the transmitting section 32 notifies the changed approximation accuracy to the control section 22. Specifically, the transmitting section 32 changes the approximation accuracy for use in approximation of the depth information, and transmits, to the receiving section 21 of the image communication apparatus 2A, a parameter including the changed approximation accuracy.

The approximation accuracy indicates a degree of an error in approximation of the depth information. For example, when a quantization range (described later) becomes narrower, the error becomes smaller. Consequently, the approximation accuracy becomes higher. Meanwhile, when the quantization range becomes wider, the error becomes larger. Consequently, the approximation accuracy becomes lower.

The control section 22 of the image communication apparatus 2A carries out approximation of the depth information according to the approximation accuracy received by the receiving section 21. For example, in order to carry out approximation of the depth information so as to increase the approximation accuracy, the control section 22 of the image communication apparatus 2A narrows the quantization range (described later) and quantizes the depth information. Meanwhile, in order to carry out approximation of the depth information so as to reduce the approximation accuracy, the control section 22 of the image communication apparatus 2A widens the quantization range (described later) and quantizes the depth information.

The receiving section 21 of the image communication apparatus 2A receives the parameter including the approximation accuracy for use in approximation of the depth information, the approximation accuracy having been determined according to the content of the action of the moving body. It should be noted that the approximation accuracy for use in approximation of the depth information may sometimes be called a “quantization range”.

The control section 22 reduces an information amount of the depth information by carrying out approximation of the depth information according to the approximation accuracy. The approximation accuracy may be an approximation accuracy having been changed by the server apparatus 3A.

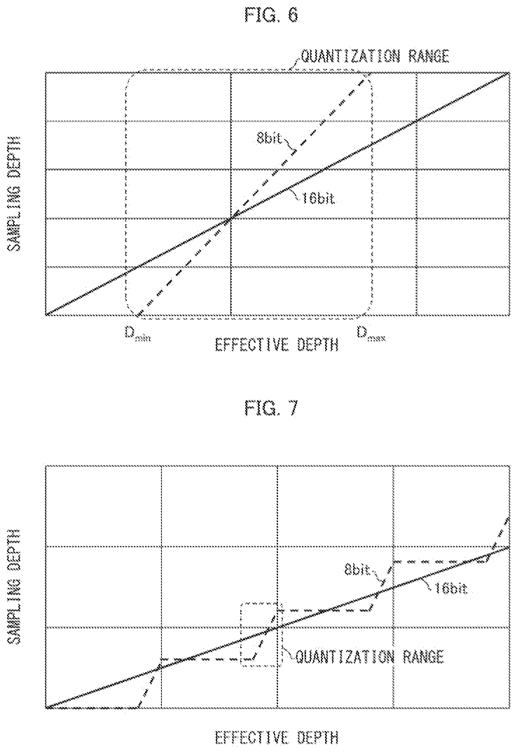

FIG. 6 is a view for illustrating a quantization range of depth information. The depth information represents distances (depths) to objects corresponding to pixels of a color image by, e.g., 16 bits (0 to 65535 [mm]). An effective depth is defined as a depth range from a lower limit value Dₘᵢₙ to an upper limit value Dₘₐₓ. As shown in FIG. 6, given that a horizontal axis indicates an effective depth of an RGB-D camera and a vertical axis indicates a sampling depth, the quantization range is defined by the lower limit value Dₘᵢₙ and the upper limit value Dₘₐₓ of the effective depth used in a quantization process on a depth image. It should be noted that a 16-bit depth image is indicated by a solid line, and an 8-bit depth image is indicated by a broken line.

The “quantization” herein includes changing a degree of discreteness of a discrete value and/or carrying out downsampling for information represented by the discrete value.

Assume that, in the present example embodiment, the depth information is quantized in the quantization range. A scale factor s in the quantization range is as represented by the following formula (formula 1).

$$s = 255 / ( {D}_{max} - {D}_{min} ) \qquad ( formula 1 )$$

Assuming that a pixel at the coordinate (u,v) is a pixel (u,v) and 16-bit depth information of the pixel (u,v) is I_{16 bit} (u,v), an 8-bit gray-scale image I_{8 bit} (u,v) having been quantized is as represented by the following formula (formula 2). In the following formula (formula 2), a value of the 8-bit gray-scale image I_{8 bit} (u,v) is set so as to fall within a range of 0 to 255.

$${I}_{8 bit} ( u , v ) = max ( 0 , min ( 255 , s \times ( {I}_{16 bit} ( u , v ) - {D}_{min} ) ) ) \qquad ( formula 2 )$$

FIG. 7 is a view illustrating 16-bit depth information and 8-bit gray-scale information. As shown in FIG. 7, in a case where the 16-bit depth information is quantized and converted into the 8-bit gray-scale information, a step-form graph is obtained. Thus, in 8 bits, a quantization error larger than that in 16 bits is generated. This quantization error eₛ is as represented by the following formula (formula 3). This shows that as the quantization range becomes narrower, the quantization error becomes smaller.

$${e}_{s} = {s}^{{}_{- 1}} \qquad ( formula 3 )$$

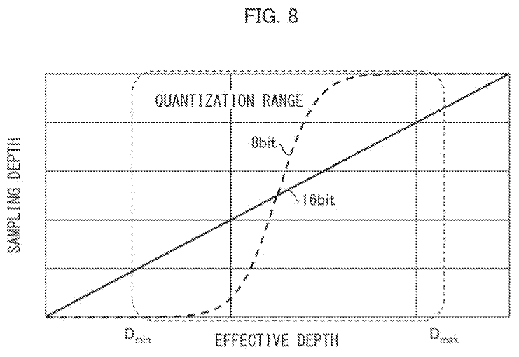

FIG. 8 is a view illustrating another example of the quantization process. As shown in FIG. 8, a 16-bit depth image may be converted by using a sigmoid function, rather than by 8-bit linear conversion. The sigmoid function is as represented by the following formula (formula 4).

$$f ( x ) = 1 / ( 1 + {e}^{{}_{- ax}} ) \qquad ( formula 4 )$$

In this case, the quantization range is not explicitly defined by a lower limit value Dₘᵢₙ and an upper limit value Dₘₐₓ as in linear conversion, but is controlled by a parameter a of the sigmoid function represented in (formula 4).

The image processing section 35 of the server apparatus 3A detects an obstacle on the basis of the depth information. For example, while the moving body is traveling, the image processing section 35 may detect an obstacle by a recognition process on a color image. In such a case, the image processing section 35 notifies a result of the recognition to the transmitting section 32.

The transmitting section 32 of the server apparatus 3A changes the approximation accuracy of the depth information according to the content of the action of the moving body and the result of the detection of the obstacle.

The receiving section 21 of the image communication apparatus 2A may receive a parameter including the approximation accuracy of the depth information, the approximation accuracy having been determined according to the content of the action of the moving body and the obstacle detected on the basis of the depth information. For example, while the moving body is traveling, an obstacle may be detected by the recognition process of the color image. In such a case, the control section 22 can carry out a quantization process with a limited quantization range of the depth information, thereby reducing a quantization error.

The changing section 22 of the image communication apparatus 2A may include an obstacle detecting means configured to detect an obstacle on the basis of an image obtained from a sensor, and the control section 22 may change the approximation accuracy of the depth information according to the content of the action of the moving body and the result of the detection of the obstacle. By compressing the depth information having been subjected to the quantization process, the control section 22 can more efficiently change the information amount of the depth information.

According to the content of the action of the moving body, the control section 22 controls a compression rate of an image obtained from the sensor. For example, in a case where the moving body is an automated guided forklift and the automated guided forklift is “traveling”, the control section 22 changes the compression rate of the color image so as to increase an information amount of the color image.

The transmitting section 32 of the server apparatus 3A changes, according to the content of the action of the moving body, a ratio of bit rates assigned to the image and the depth information.

The receiving section 21 of the image communication apparatus 2A receives a parameter including the ratio of the bit rates assigned to the image and the depth information, the ratio having been determined according to the content of the action of the moving body.

The transmitting section 23 transmits, to the server apparatus 3A, the depth information quantized and compressed by the control section 22 and the color image compressed by the control section 22. The transmitting section 23 can estimate a communication throughput on the basis of stream distribution information of the color image and the depth information and obtain a transmittable band.

Assuming that the transmittable band is B (bps) and the assignment ratio of the bit rates is r, the bit rate for the color image, denoted by b_{RGB} (bps), and the bit rate for the depth image, denoted by b_{Depth} (bps), are as represented by the following formulae (formula 5) and (formula 6). It should be noted that the assignment ratio r is controlled within a range from 0 to 1 according to the content of the action of the robot.

$${b}_{RGB} = ( 1 - r ) \times B \qquad ( formula 5 )$$

$${b}_{Depth} = r \times B \qquad ( formula 6 )$$

The transmitting section 32 of the server apparatus 3A changes the bit rate for the image and the bit rate for the depth information according to the communication throughput of a network to which the moving body is connected. As described above, the bit rate for the color image is b_{RGB} (bps) and the bit rate for the depth image is b_{Depth} (bps).

### <Flow of Moving Body Control Method by Moving Body Control System 100A>

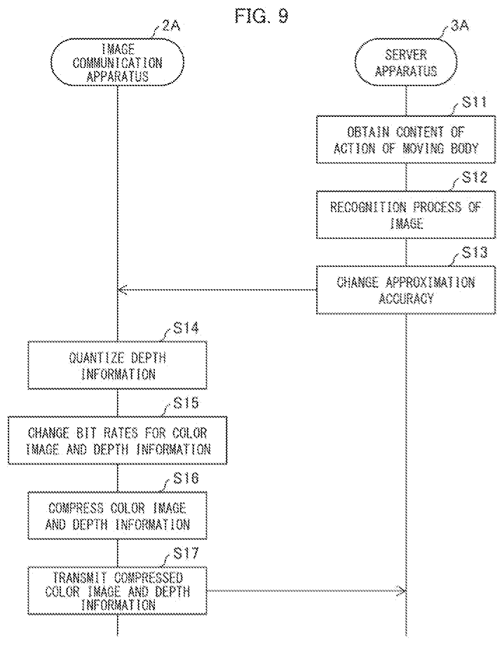

The following will describe, with reference to FIG. 9, a flow of a moving body control method executed by the moving body control system 100A configured as above. FIG. 9 is a flowchart illustrating a flow of the moving body control method. As shown in FIG. 9, the moving body control method includes steps S11 to S17.

First, the obtaining section 31 of the server apparatus 3A obtains a content of action of a moving body and notifies the content of the action of the moving body to the transmitting section 32 (S11). The content of the action of the moving body is managed by another server apparatus. The obtaining section 31 of the server apparatus 3A obtains, from another server apparatus or the like, information relating to the content of the action of the moving body.

Next, the image processing section 35 of the server apparatus 3A carries out a recognition process on at least one of the color image and the depth information, and notifies a result of the recognition to the transmitting section 32 of the server apparatus 3A (S12).

According to the content of the action of the moving body and the result of the recognition carried out by the image processing section 35, the transmitting section 32 of the server apparatus 3A changes a depth range of the depth image, an assigned bit rate amount for the color image, and an assigned bit rate amount for the depth image; then, the transmitting section 32 incorporates the changed information into a parameter, and transmits the parameter to the image communication apparatus 2A (S13).

Upon reception of the parameter from the server apparatus 3A, the receiving section 21 of the image communication apparatus 2A notifies, to the control section 22, the approximation accuracy, the assigned bit rate amount for the color image, and the assigned bit rate amount for the depth image. The control section 22 reduces an information amount of the depth information by quantizing the depth information according to the approximation accuracy (S14).

Further, the control section 22 changes the bit rates for the color image and the depth information according to the assigned bit rate amount for the color image and the assigned bit rate amount for the depth information received from the server apparatus 3A (S15), and compresses the color image and the depth information according to the respective bit rates (S16).

Lastly, the transmitting section 23 of the image communication apparatus 2A transmits, to the server apparatus 3A, the compressed color image and the compressed depth information (S17).

It should be noted that functions of the moving body control system 100A may be implemented in a cloud. For example, the obtaining section 31 and the transmitting section 32 may be a single apparatus, and the image processing section 35 and the receiving section 37 may be a single apparatus. These sections may be mounted in a single apparatus or in different apparatuses. For example, in a case where these sections are mounted in respective different apparatuses, information of these sections is exchanged via a communication network so as to proceed with a process.

### <Effects of Moving Body Control System 100A>

As described above, with the moving body control system 100A in accordance with the present example embodiment, the transmitting section 32 of the server apparatus 3A changes the approximation accuracy of the depth information according to the content of the action of the moving body, and notifies the changed approximation accuracy to the control section 22. Thus, by quantizing the depth information according to the approximation accuracy, the control section 22 of the image communication apparatus 2A can reduce the information amount of the depth information.

The transmitting section 32 of the server apparatus 3A changes the approximation accuracy of the depth information according to the content of the action of the moving body and the result of the recognition carried out by the image processing section 35, and notifies the changed approximation accuracy to the control section 22. Thus, by quantizing the depth information according to the approximation accuracy, the control section 22 of the image communication apparatus 2A can more suitably reduce the information amount of the depth information.

Further, since the control section 22 of the image communication apparatus 2A changes the information amount of the depth information by changing the compression rate of the depth information, it is possible to make the information amount of the depth information correspond to the assignment ratio of the bit rate for the depth information.

Further, since the control section 22 of the image communication apparatus 2A changes the information amount of the color image by changing the compression rate of the color image according to the content of the action of the moving body, it is possible to make the information amount of the color image correspond to the assignment ratio of the bit rate for the color image.

Further, since the transmitting section 32 of the server apparatus 3A changes the bit rate for the color image and the bit rate for the depth information according to the communication throughput of the transmitting section 23 of the image communication section 2A, it is possible to make the information amounts of the color image and depth information correspond to the communication throughput.

### Fifth Example Embodiment

The following description will discuss a fifth example embodiment of the present invention in detail with reference to the drawings. It should be noted that members having identical functions to those of the second to fourth third example embodiments are given identical reference signs, and a description thereof will be omitted.

### <Configuration of Robot Control System 100B>

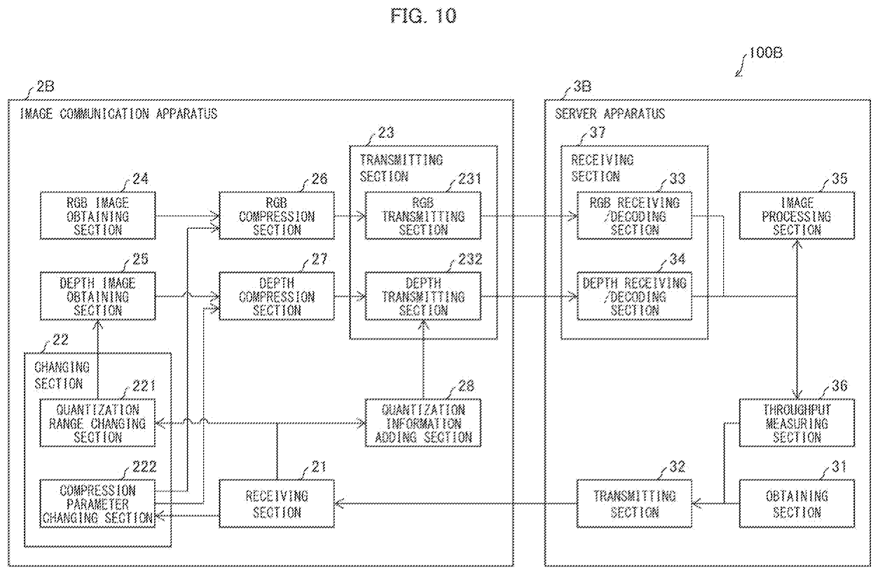

The following will describe, with reference to FIG. 10, a configuration of a moving body control system 100B in accordance with the present example embodiment. FIG. 10 is a block diagram illustrating a configuration of the moving body control system 100B.

As shown in FIG. 10, the moving body control system 100B includes an image communication apparatus 2B and a server apparatus 3B. The image communication apparatus 2B includes a receiving section 21, a changing section 22, a transmitting section 23, an RGB image obtaining section 24, a depth image obtaining section 25, an RGB compression section 26, a depth compression section 27, and a quantization information adding section 28. The changing section 22 includes a quantization range changing section 221 and a compression parameter changing section 222. The transmitting section 23 includes an RGB transmitting section 231 and a depth transmitting section 232.

The server apparatus 3B includes an obtaining section 31, a transmitting section 32, an image processing section 35, a throughput measuring section 36, and a receiving section 37. The receiving section 37 includes an RGB receiving/decoding section 33, and a depth receiving/decoding section 34.

The receiving section 21 of the image communication apparatus 2B receives, from the server apparatus 3B, a parameter including approximation accuracy (quantization range) of depth information, the approximation accuracy having been determined according to a content of action of a moving body. Then, the receiving section 21 outputs the parameter to the quantization range changing section 221 and the quantization information adding section 28. The receiving section 21 of the image communication apparatus 2B receives, from the server apparatus 3B, a parameter including an assignment ratio of a bit rate for a color image and a bit rate for depth information. Then, the receiving section 21 outputs the parameter to the compression parameter changing section 222.

The quantization range changing section 221 outputs, to the depth image obtaining section 25, the quantization range received from the receiving section 21, so as to change the quantization range.

The RGB image obtaining section 24 obtains the color image from the sensor. The depth image obtaining section 25 obtains the depth information from the sensor. As described in the fourth example embodiment, the depth image obtaining section 25 reduces the information amount of the depth information by quantizing the depth information according to the quantization range.

The RGB compression section 26 compresses, according to the compression parameter for the color image output from the compression parameter changing section 222, the color image output from the RGB image obtaining section 24. Then, the RGB compression section 26 outputs the compressed color image to the RGB transmitting section 231. The RGB transmitting section 231 transmits, to the server apparatus 3B, the color image compressed by the RGB compression section 26.

The depth compression section 27 compresses, according to the compression parameter of the depth image output from the compression parameter changing section 222, the depth image having been subjected to a quantization process output from the depth image obtaining section 25. Then, the depth compression section 27 outputs the compressed depth image to the depth transmitting section 232.

The quantization information adding section 28 adds quantization information to a packet for transmitting the depth information having been compressed by the depth compression section 27, and causes the depth transmitting section 232 to transmit, to the server apparatus 3B, the packet having the quantization information added thereto.

The obtaining section 31 of the server apparatus 3B obtains a content of action of a moving body. The content of the action of the moving body is managed by another server apparatus. The obtaining section 31 of the server apparatus 3B obtains, from another server apparatus or the like, information relating to the content of the work of the moving body.

The transmitting section 32 of the server apparatus 3B changes, according to the content of the action of the moving body, approximation accuracy of the depth information, and transmits the changed approximation accuracy to the image communication apparatus 2B. Further, the transmitting section 32 may change an approximation range of the depth information according to the content of the action of the moving body and a result of recognition carried out by the image processing section 35, and may transmit the changed approximation accuracy to the image communication apparatus 2B.

The image processing section 35 carries out a recognition process on at least one of a color image and depth information. For example, while the moving body is traveling, the image processing section 35 may detect an obstacle by the recognition process of the color image. In such a case, the image processing section 35 notifies a result of the recognition to the transmitting section 32.

The throughput measuring section 36 measures a period of time taken to receive a given number of packets from the image communication apparatus 2B, for example. Then, the throughput measuring section 36 measures a communication throughput on the basis of a data amount of the given number of packets and the period of time taken to receive the given number of packets. The throughput measuring section 36 then notifies the communication throughput to the transmitting section 32.

The RGB receiving/decoding section 33 receives the compressed color image e from the image communication apparatus 2B, and decodes the compressed color image. The depth receiving/decoding section 34 receives the compressed depth information from the image communication apparatus 2B, and decodes the compressed depth information.

### <Flow of Moving Body Control Method by Moving Body Control System 100B>

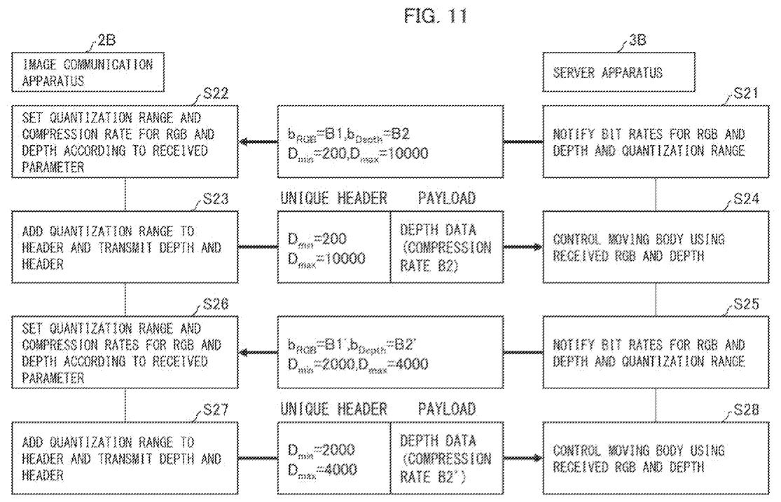

The following will describe, with reference to FIG. 11, a flow of a moving body control method executed by the moving body control system 100B configured as above. FIG. 11 is a flowchart illustrating a flow of the moving body control method. As shown in FIG. 11, the moving body control method includes steps S21 to S28. The following will describe an example case where the color image is an RGB image.

First, the obtaining section 31 of the server apparatus 3B obtains a content of action of a moving body, and notifies the content of the action of the moving body to the transmitting section 32. The transmitting section 32 changes, according to the content of the action of the moving body, an assignment ratio of a bit rate for an RGB image and a bit rate for depth information and a quantization range, and notifies the assignment ratio of the bit rates and the quantization range to the image communication apparatus 2B (S21). In FIG. 11, the bit rate for the RGB image is represented as “B1”, the bit rate for the depth information is represented as “B2”, a lower limit value Dₘᵢₙ of the quantization range is 200, and an upper limit value Dₘₐₓ of the quantization range is 10000.

Upon reception of the assignment ratio of the bit rates and the quantization range, the receiving section 21 of the image communication apparatus 2B outputs the quantization range to the quantization range changing section 221, and outputs the assignment ratio of the bit rates to the compression parameter changing section 222. The quantization range changing section 221 inputs and sets the quantization range in the depth image obtaining section 25. The compression parameter changing section 222 sets a compression parameter (compression rate) for the RGB image in the RGB compression section 26, and sets a compression parameter (compression rate) for the depth image in the depth compression section 27 (S22).

Next, the depth transmitting section 232 transmits the depth image compressed by the depth compression section 27 in such a manner that the quantization information adding section 28 adds the quantization range to a header of a packet for transmitting the depth information and causes the depth transmitting section 232 to transmit the depth image and the header (S23). In FIG. 11, a unique header of the packet for transmitting the depth information has the lower limit value 200 of the quantization range and the upper limit value 10000 of the quantization range added thereto, and a payload has a depth image (data) of a compression rate B2 stored therein.

Next, the receiving section 37 of the server apparatus 3B receives the RGB image and depth image, and decodes the RGB image and depth information thus received. Then, the receiving section 37 transmits the RGB image and depth information to another server apparatus that controls the moving body, so as to cause another server apparatus to control the moving body (S24).

Similarly, the obtaining section 31 of the server apparatus 3B obtains the content of the action of the moving body, and notifies the content of the action of the moving body to the transmitting section 32. The transmitting section 32 changes, according to the content of the action of the moving body, the assignment ratio of the bit rate for the RGB image and the bit rate for the depth information and the quantization range, and notifies the assignment ratio of the bit rates and the quantization range to the image communication apparatus 2B (S25). In FIG. 11, the bit rate for the RGB image is represented as “B1′”, the bit rate for the depth information is represented as “B2′”, a lower limit value Dₘᵢₙ of the quantization range is 2000, and an upper limit value Dₘₐₓ of the quantization range is 4000.

Upon reception of the assignment ratio of the bit rates and the quantization range, the receiving section 21 of the image communication apparatus 2B outputs the quantization range to the quantization range changing section 221, and outputs the assignment ratio of the bit rates to the compression parameter changing section 222. The quantization range changing section 221 inputs and sets the quantization range in the depth image obtaining section 25. The compression parameter changing section 222 sets compression parameter for the RGB image in the RGB compression section 26, and sets the compression parameter for the depth image in the depth compression section 27 (S26).

Next, the depth transmitting section 232 transmits the depth information compressed by the depth compression section 27 in such a manner that the quantization information adding section 28 adds the quantization range to the header of the packet for transmitting the depth information and causes the depth transmitting section 232 to transmit the depth image and the header (S27). In FIG. 11, a unique header of the packet for transmitting the depth information has the lower limit value 2000 of the quantization range and the upper limit value 4000 of the quantization range added thereto, and a payload has depth information (data) of a compression rate B2′ stored therein.

Next, the receiving section 37 of the server apparatus 3B receives the RGB image and depth information, and decodes the RGB image and depth information thus received. Then, the receiving section 37 transmits the RGB image and depth information to another server apparatus that controls the moving body, so as to cause another server apparatus to control the moving body (S28).

### <Effects of Moving Body Control System 100B>

As described above, with the moving body control system 100B in accordance with the present example embodiment, the quantization information adding section 28 of the image communication apparatus 2B adds the quantization information to the packet for transmitting the depth information having been compressed by the depth compression section 27, and causes the depth transmitting section 232 to transmit, to the server apparatus 3B, the packet having the quantization information added thereto. Thus, on the server apparatus 3B side, it is possible to easily check the frequently updated compression rates of the RGB image and depth information and/or the quantization range of the depth information.

Further, since the throughput measuring section 36 of the server apparatus 3B measures the communication throughput on the basis of the data amount of the given number of packets and the period of time taken to receive the given number of packets, it is possible to obtain the throughput corresponding to the communication state at that time.

### [Software Implementation Example]

Part of or the whole of functions of the image communication apparatus 2, 2A, 2B and the server apparatus 3, 3A, 3B can be realized by hardware such as an integrated circuit (IC chip) or can be alternatively realized by software.

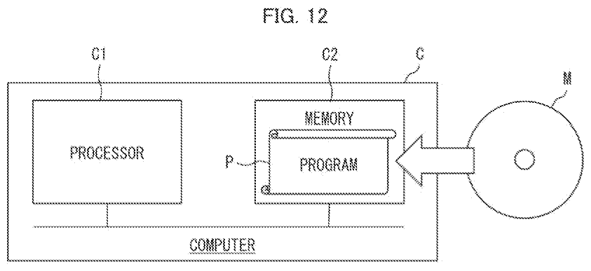

In the latter case, each of the image communication apparatus 2, 2A, 2B and the server apparatus 3, 3A, 3B is realized by, for example, a computer that executes instructions of a program that is software realizing the foregoing functions. FIG. 12 illustrates an example of such a computer (hereinafter referred to as “computer C”). The computer C includes at least one processor C1 and at least one memory C2. The memory C2 has a program P stored therein, the program P causing the computer C to operate as the image communication apparatus 2, 2A, 2B and the server apparatus 3, 3A, 3B. In the computer C, the processor C1 reads and executes the program P from the memory C2, thereby realizing the functions of the image communication apparatus 2, 2A, 2B and the server apparatus 3, 3A, 3B.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can obtain the program P via the storage medium M. The program P can also be transmitted via a transmission medium. The transmission medium may be, for example, a communications network, a broadcast wave, or the like. The computer C can obtain the program P also via the transmission medium.

### [Supplementary Remarks 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Supplementary Remarks 2]

The whole or part of the example embodiments disclosed above can also be described as below. Note, however, that the present invention is not limited to the following supplementary notes.

### (Supplementary Note 1)

A moving body control system including: an obtaining means that obtains a content of action of a moving body; and a control means that controls, according to the content of the action of the moving body, an information amount of depth information obtained from a sensor.

With the above configuration, it is possible to control, according to the content of the action of the moving body, the information amount of the depth information so that the information amount of the depth information becomes appropriate.

### (Supplementary Note 2)

The moving body control system described in Supplementary Note 1, wherein: the control means carries out approximation of the depth information according to the content of the action of the moving body.

With the above configuration, it is possible to reduce the information amount of the depth information by quantizing the depth information according to the approximation accuracy.

### (Supplementary Note 3)

The moving body control system described in Supplementary Note 2, further including: an obstacle detecting means that detects an obstacle on a basis of the depth information, wherein: the control means changes, according to the content of the action of the moving body and a result of the detection of the obstacle, approximation accuracy of the depth information.

With the above configuration, it is possible to reduce the information amount of the depth information more suitably by quantizing the depth information according to the approximation accuracy.

### (Supplementary Note 4)

The moving body control system described in Supplementary Note 2, further including: an obstacle detecting means that detects an obstacle on a basis of an image obtained from the sensor, wherein: the control means changes, according to the content of the action of the moving body and a result of the detection of the obstacle, approximation accuracy of the depth information.

With the above configuration, it is possible to reduce the information amount of the depth information more suitably by quantizing the depth information according to the approximation accuracy.

### (Supplementary Note 5)

The robot control system described in Supplementary Note 3 or 4, wherein: the control means controls, according to the content of the action of the moving body, a compression rate of an image obtained from the sensor.

With the above configuration, it is possible to make the information amount of the image correspond to an assignment ratio of a bit rate for the image.

### (Supplementary Note 6)

The moving body control system described in Supplementary Note 5, wherein: the control means changes, according to the content of the action of the moving body, a ratio of bit rates assigned to the image and the depth information.

With the above configuration, it is possible to make the information amounts of the image and the depth information correspond to the bit rates for the image and the depth information.

### (Supplementary Note 7)

The moving body control system described in Supplementary Note 5 or 6, wherein: the control means changes, according to a communication throughput of a network to which the moving body is connected, a bit rate for the image and a bit rate for the depth information.

With the above configuration, it is possible to make the information amounts of the image and the depth information correspond to an assignment ratio of the bit rates for the image and the depth information.

### (Supplementary Note 8)

A moving body control method including: obtaining a content of action of a moving body; and controlling, according to the obtained content of the action of the moving body, an information amount of depth information obtained from a sensor.

With the above configuration, it is possible to control, according to the content of the action of the moving body, the information amount of the depth information so that the information amount of the depth information becomes appropriate.

### (Supplementary Note 9)

The moving body control method described in Supplementary Note 8, wherein: in changing the information amount, approximation of the depth information is carried out according to the content of the action of the moving body.

With the above configuration, it is possible to reduce the information amount of the depth information by carrying out approximation of the depth information according to the approximation accuracy.

### (Supplementary Note 10)

The moving body control method described in Supplementary Note 9, further including: detecting an obstacle on a basis of the depth information, wherein: in changing the information amount, approximation accuracy of the depth information is changed according to the content of the action of the moving body and a result of the detection of the obstacle.

With the above configuration, it is possible to reduce the information amount of the depth information by carrying out approximation of the depth information according to the approximation accuracy.

### (Supplementary Note 11)

The moving body control method described in Supplementary Note 10, further including: detecting an obstacle on a basis of an image obtained from the sensor, wherein: in changing the information amount, approximation accuracy of the depth information is changed according to the content of the action of the moving body and a result of the detection of the obstacle.

With the above configuration, it is possible to reduce the information amount of the depth information by carrying out approximation of the depth information according to the approximation accuracy.

### (Supplementary Note 12)

The moving body control method described in Supplementary Note 10 or 11, wherein: in changing the information amount, a compression rate of an image obtained from the sensor is controlled according to the content of the action of the moving body.

With the above configuration, it is possible to make the information amount of the image correspond to an assignment ratio of a bit rate for the image.

### (Supplementary Note 13)

The moving body control method described in Supplementary Note 12, wherein: in changing the information amount, a ratio of bit rates assigned to the image and the depth information is changed according to the content of the action of the moving body.

With the above configuration, it is possible to make the information amounts of the image and the depth information correspond to the bit rates for the image and the depth information.

### (Supplementary Note 14)

The moving body control method described in Supplementary Note 12 or 13, wherein: in changing the information amount, a bit rate for the image and a bit rate for the depth information are changed according to a communication throughput of a network to which the moving body is connected.

With the above configuration, it is possible to make the information amounts of the image and the depth information correspond to an assignment ratio of the bit rates for the image and the depth information.

### (Supplementary Note 15)

An image communication apparatus including: a receiving means that receives a parameter relating to a change in information amount, the change having been determined according to a content of action of a moving body; and a control means that controls, according to the parameter, an information amount of depth information obtained from a sensor.

With the above configuration, it is possible to control, according to the content of the action of the moving body, the information amount of the depth information so that the information amount of the depth information becomes appropriate.

### (Supplementary Note 16)

The image communication apparatus described in Supplementary Note 15, wherein: the receiving means receives the parameter including approximation accuracy for use in approximation of the depth information, the approximation accuracy having been determined according to the content of the action of the moving body; and the control means carries out approximation of the depth information according to the approximation accuracy, so as to reduce an information amount of the depth information.

With the above configuration, it is possible to reduce the information amount of the depth information by carrying out approximation of the depth information according to the approximation accuracy.

### (Supplementary Note 17)

The image communication apparatus described in Supplementary Note 16, wherein: the receiving means receives the parameter including the approximation accuracy of the depth information, the approximation accuracy having been determined according to the content of the action of the moving body and an obstacle detected on a basis of the depth information.

With the above configuration, it is possible to reduce the information amount of the depth information more suitably by carrying out approximation of the depth information according to the approximation accuracy.

### (Supplementary Note 18)

The image communication apparatus described in Supplementary Note 17, wherein: the receiving means receives the parameter including the approximation accuracy of the depth information, the approximation accuracy having been determined according to the content of the action of the moving body and an obstacle detected on a basis of an image obtained from the sensor.

With the above configuration, it is possible to reduce the information amount of the depth information more suitably by carrying out approximation of the depth information according to the approximation accuracy.

### (Supplementary Note 19)

The image communication apparatus described in Supplementary Note 17 or 18, wherein: the control means controls, according to the parameter determined according to the content of the action of the moving body, a compression rate of an image obtained from the sensor.

With the above configuration, it is possible to make the information amount of the image correspond to an assignment ratio of a bit rate for the image.

### (Supplementary Note 20)

The image communication apparatus described in Supplementary Note 19, wherein: the receiving means receives the parameter including a ratio of bit rates assigned to the image and the depth information, the ratio having been determined according to the content of the action of the moving body.

With the above configuration, it is possible to make the information amounts of the image and the depth information correspond to the bit rates for the image and the depth information.

### (Supplementary Note 21)

The image communication apparatus described in Supplementary Note 19 or 20, wherein: the receiving means receives a bit rate for the image and a bit rate for the depth information, each of the bit rates having been determined according to a communication throughput of a network to which the moving body is connected.

With the above configuration, it is possible to make the information amounts of the image and the depth information correspond to an assignment ratio of the bit rates for the image and the depth information.

### (Supplementary Note 22)

A moving body control system including at least one processor, the at least one processor executing: a process of obtaining a content of action of a moving body; and a process of controlling, according to the obtained content of the action of the moving body, an information amount of depth information obtained from a sensor.

Note that the robot control system may further include a memory, wherein the memory may have a program stored therein, the program causing the processor to execute the obtaining process and the controlling process. This program may be stored in a non-transitory, tangible computer-readable storage medium.

### (Supplementary Note 23)

An image communication apparatus including at least one processor, the at least one processor executing: a process of receiving a parameter relating to a change in information amount, the change having been determined according to a content of action of a moving body; and a process of controlling, according to the parameter, an information amount of depth information obtained from a sensor.

Note that the image communication apparatus may further include a memory and the memory may have a program stored therein, the program causing the processor to execute the receiving process and the controlling process. This program may be stored in a non-transitory, tangible computer-readable storage medium.

### (Supplementary Note 24)

The robot control system described in Supplementary Note 3, wherein: the changing means changes an information amount of the depth image by changing a compression rate of the depth image.

### (Supplementary Note 25)

A server apparatus including: an obtaining means that obtains a content of action of a robot; and a transmitting means that determines, according to the content of the action of the robot, a parameter for changing an information amount of a depth image obtained from a camera and transmits the parameter to the robot.

### (Supplementary Note 26)

The server apparatus described in Supplementary Note 25, wherein: the transmitting means transmits, to the robot, the parameter including a depth range of a quantization target in the depth image, the depth range having been changed according to the content of the action of the robot.

### REFERENCE SIGNS LIST

2, 2A, 2B: image transmitting apparatus
3, 3A, 3B: server apparatus
11, 31: obtaining section
12, 22: control section
21, 37: receiving section
23, 32: transmitting section
24: RGB image obtaining section
25: depth image obtaining section
26: RGB compression section
27: depth compression section
28: quantization information adding section
33: RGB receiving/decoding section
34: depth receiving/decoding section
35: image processing section
36: throughput measuring section
100, 100A, 100B: robot control system
231: RGB transmitting section
232: depth transmitting section

What is claimed is:

1. A moving body control system comprising at least one processor, the at least one processor executing:
obtaining a content of action of a moving body; and
controlling, according to the content of the action of the moving body, an information amount of depth information obtained from a sensor.

2. The moving body control system according to claim 1, wherein:
in the controlling, the at least one processor carries out approximation of the depth information according to the content of the action of the moving body.

3. The moving body control system according to claim 2, wherein:
the at least one processor executes detecting an obstacle on a basis of the depth information; and
in the controlling, the at least one processor determines, according to the content of the action of the moving body and a result of the detection of the obstacle, approximation accuracy of the depth information.

4. The moving body control system according to claim 2, wherein:
the at least one processor executes detecting an obstacle on a basis of an image obtained from the sensor; and
in the controlling, the at least one processor determines, according to the content of the action of the moving body and a result of the detection of the obstacle, approximation accuracy of the depth information.

5. The moving body control system according to claim 3, wherein:
in the controlling, the at least one processor controls, according to the content of the action of the moving body, a compression rate of an image obtained from the sensor.

6. The moving body control system according to claim 5, wherein:
in the controlling, the at least one processor determines, according to the content of the action of the moving body, a ratio of bit rates assigned to the image and the depth information.

7. The moving body control system according to claim 5, wherein:
in the controlling, the at least one processor determines, according to a communication throughput of a network to which the moving body is connected, a bit rate for the image and a bit rate for the depth information.

8. A moving body control method comprising:
obtaining a content of action of a moving body; and
controlling, according to the obtained content of the action of the moving body, an information amount of depth information obtained from a sensor.

9. The moving body control method according to claim 8, wherein:
in controlling the information amount, approximation of the depth information is carried out according to the content of the action of the moving body.

10. The moving body control method according to claim 9, further comprising:
detecting an obstacle on a basis of the depth information, wherein:
in controlling the information amount, approximation accuracy of the depth information is determined according to the content of the action of the moving body and a result of the detection of the obstacle.

11. The moving body control method according to claim 9, further comprising:
detecting an obstacle on a basis of an image obtained from the sensor, wherein:
in controlling the information amount, approximation accuracy of the depth information is determined according to the content of the action of the moving body and a result of the detection of the obstacle.

12. The moving body control method according to claim 10 or 11, wherein:
in controlling the information amount, a compression rate of an image obtained from the sensor is controlled according to the content of the action of the moving body.

13. The moving body control method according to claim 12, wherein:
in controlling the information amount, a ratio of bit rates assigned to the image and the depth information is determined according to the content of the action of the moving body.

14. The moving body control method according to claim 12, wherein:
in controlling the information amount, a bit rate for the image and a bit rate for the depth information are determined according to a communication throughput of a network to which the moving body is connected.

15. An image communication apparatus comprising at least one processor, the at least one processor executing:
receiving a parameter relating to a change in information amount, the change having been determined according to a content of action of a moving body; and
controlling, according to the parameter, an information amount of depth information obtained from a sensor.

16. The image communication apparatus according to claim 15, wherein:
in the receiving, the at least one processor receives the parameter including approximation accuracy for use in approximation of the depth information, the approximation accuracy having been determined according to the content of the action of the moving body; and
in the controlling, the at least one processor carries out approximation of the depth information according to the approximation accuracy, so as to reduce an information amount of the depth information.

17. The image communication apparatus according to claim 16, wherein:
in the receiving, the at least one processor receives the parameter including the approximation accuracy of the depth information, the approximation accuracy having been determined according to the content of the action of the moving body and an obstacle detected on a basis of the depth information.

18. The image communication apparatus according to claim 16, wherein:
in the receiving, the at least one processor receives the parameter including the approximation accuracy of the depth information, the approximation accuracy having been determined according to the content of the action of the moving body and an obstacle detected on a basis of an image obtained from the sensor.

19. The image communication apparatus according to claim 17, wherein:
in the controlling, the at least one processor controls, according to the parameter determined according to the content of the action of the moving body, a compression rate of an image obtained from the sensor.

20. The image communication apparatus according to claim 19, wherein:
in the receiving, the at least one processor receives the parameter including a ratio of bit rates assigned to the image and the depth information, the ratio having been determined according to the content of the action of the moving body.

21. (canceled)
